(19) United States
(12) Patent Application Publication
(10) Pub. No.: US 2018/0213873 A1
(43) Pub. Date: Aug. 2, 2018

(54) ATTACHMENT FOR A HELMET FOR MONITORING, DISPLAYING, RECORDING, AND STORING DATA

(71) Applicants: Dustin Brice, Palm Beach Gardens, FL (US); Geoffrey Haynes, Palm Beach Gardens, FL (US)

(72) Inventors: Dustin Brice, Palm Beach Gardens, FL (US); Geoffrey Haynes, Palm Beach Gardens, FL (US)

(21) Appl. No.: 15/886,931

(22) Filed: Feb. 2, 2018

Related U.S. Application Data
(60) Provisional application No. 62/453,613, filed on Feb. 2, 2017.

(51) Int. Cl. A42B 3/04; G01P 15/18

(52) U.S. Cl. CPC A42B 3/0426; A42B 3/046; G01P 15/18

(57) ABSTRACT

An attachment for a helmet including a first housing and a second housing. The first housing includes a first camera configured for capturing data from a first perspective relative to the helmet, a sensor for capturing accelerometer data, a database for storing the data, and a processing unit configured for displaying a graphical representation on a display corresponding to at least the first visual data. The includes a second housing encasing a second camera for capturing data from a second perspective relative to the helmet, and, the display configured to be positioned such that a user can view the display when the helmet is worn. The processor switches to a storing mode after the event has occurred. In the storing mode, data received from a predetermined amount of time before the event occurs and a second predetermined amount of time after the event occurs is stored in the database.

### CROSS-REFERENCE TO RELATED APPLICATIONS

This application claims the benefit of the filing date of U.S. Provisional Application Ser. No. 62/453,613 titled “SYSTEM FOR MONITORING, DISPLAYING, RECORDING, AND STORING ENVIRONMENTAL DATA” and filed Feb. 2, 2017 and the subject matter of which is incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of helmets, and more specifically, to the field of devices related for use attaching to helmets.

### BACKGROUND

The four largest motorcycle markets in the world are all in Asia: China, India, Indonesia, and Vietnam. India, with an estimated 37 million motorcycles/mopeds, was home to the largest number of motorized two wheelers in the world. China came a close second with 34 million motorcycles/mopeds in 2002. In 2015, 4,976 people died in motorcycle crashes, up 8.3 percent from 4,594 in 2014, per the National Highway Traffic Safety Administration (NHTSA). In 2014, motorcyclists were 27 times more likely than passenger car occupants to die in a crash per vehicle mile traveled, and almost five times more likely to be injured. To prevent motorcycle injuries, many people will wear motorcycle helmets.

While riding motorcycles, many people will use the side mirrors to have a perspective of what is behind the motorcycle rider. However, in addition to side mirrors providing a limited filed of view, one of the issues with many side mirrors is that a motorcycle rider in the case of “sport” motorcycles must be in a bent over position to properly view the surroundings behind the rider via the side view mirrors. This is an issue when a motorcycle rider is at a stop. When a motorcycle rider is at a stop, the motorcycle rider is in an upright position and thereby is not able to use side view mirrors to see behind the rider. Thus, the motorcycle rider does not know if a vehicle is not coming to a complete stop and therefore cannot take measures to avoid an accident as he or she would have been able to if they would have known of the vehicle that is not coming to a complete stop.

Another major issue that plagues motorcycle riders and other motor vehicle passengers is lack of information related to an event or traffic accident. It is understood that the terms “event”, “traffic accident” and “accident”, “crash event” may be used interchangeably throughout this application. In many cases, after an event occurs, it is difficult to ascertain exactly what happened during the event because as time progresses memories tend to fade, witnesses move away or relocate, or in the case of serious injury to the rider, they are unable to recall the details of the accident etc.

Devices have been used to capture environmental data and for storing the environmental data for use or viewing at a later time. However, one issue with such recording devices that record environmental data is that the databases or storage units that are used for storing the corresponding digital data require constant changing due to storage capacity concerns. This constant changing is very inefficient, costly and time consuming

As a result, there is a need for improvements over the prior art to provide a better way to capture event data and a more effective way to provide rear views to a motorcycle rider.

### SUMMARY

A system for monitoring, displaying, recording, and storing environmental data is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, an attachment for monitoring, displaying, recording, and an attachment for a helmet including a first housing for mounting onto an outward facing portion of the helmet. The first housing encases a first camera configured for capturing a plurality of first visual data from a first perspective relative to the helmet, a sensor for capturing accelerometer data relative to the helmet, a database for storing the first visual data, second visual data and accelerometer data, a processing unit in communication with the first camera, the second camera, the sensor, the database and a display, wherein the processing unit is configured for receiving first visual data, second visual data, and accelerometer data, storing first visual data, second visual data, and accelerometer data in the database, and for displaying a graphical representation on the display corresponding to at least the first visual data. The attachment also includes a second housing connected to the first housing. The second housing encases a second camera for capturing a plurality of second visual data from a second perspective relative to the helmet, and, the display configured to be positioned such that a user can view the display when the helmet is worn by the user.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a side perspective view of a system or attachment for a helmet for monitoring, displaying, recording, and storing data, according to an example embodiment;

FIG. 2 is a rear perspective view of the system or attachment for a helmet for monitoring, displaying, recording, and storing data, according to an example embodiment;

FIG. 3 is a front perspective view of the system or attachment for a helmet for monitoring, displaying, recording, and storing data, according to an example embodiment;

FIG. 3A is a diagram of a top view perspective of a helmet, illustrating the front prospective, rear perspective and areas surrounding the helmet that the first and second cameras may record, according to an example embodiment;

FIG. 4 is a first perspective view of a first housing for the system or attachment for a helmet for monitoring, displaying, recording, and storing data, according to an example embodiment;

FIG. 5 is a second perspective view of the first housing for the system or attachment for a helmet for monitoring, displaying, recording, and storing data, according to an example embodiment;

FIG. 6 is a first perspective view of a second housing illustrating a display of the system or attachment for a helmet for monitoring, displaying, recording, and storing data, according to an example embodiment;

FIG. 6A is a front view of the second housing illustrating a second content capturing device of the system or attachment for a helmet for monitoring, displaying, recording, and storing data, according to an example embodiment;

FIG. 6B is a second perspective view of the second housing illustrating a graphical representation of visual data displayed on the display, according to an example embodiment;

FIG. 6C is a third perspective view of the second housing illustrating a graphical representation of visual data displayed on the display while worn by a user, according to an example embodiment;

FIG. 7 is a block diagram of the main electrical elements of for the system or attachment for a helmet for monitoring, displaying, recording, and storing data, according to an example embodiment;

FIG. 7B is a process flow diagram of illustrating one of the processes of the system or attachment for a helmet for monitoring, displaying, recording, and storing data, according to an example embodiment; and,

FIG. 7C is a diagram of the time periods, for illustrative purposes, during which data is captured by a first data capturing device and second data capturing device of the system or attachment for a helmet for monitoring, displaying, recording, and storing data, according to an example embodiment; and,

FIG. 8 is a block diagram of a system including an example computing device 800 and other computing devices.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system for providing both forward and rear facing cameras better configured to capture the surrounding audio and visual events environment both in front of and behind a user. The system also provides a rear-view display proximate to a user's eye or eyesight so that he or she does not have to be hunched over on a motorcycle to view surroundings or environments behind the user. Additionally, the system is configured to determine when a crash event occurs using accelerometer or other data received. After it is determined that a crash event has occurred, the system can record, and store in an attached database, data that occurred both before and after a crash event from both the front facing camera and rear facing cameras as well as data from other sensors. This crash event data is useful for determining what occurred both before and after a crash event or accident. The system also improves the prior art by providing a more efficient way to record data for a crash event while not having to change storage units or tapes frequently by having a looping mode and a storing mode. The system and attachment captures 320 degrees of data around the rider for analysis if an incident occurs. The system also improves over the prior art by providing a system that allows the user to control the system, such as to turn on and off the system, by using a predetermined pattern of motion which is detected by the sensor, such as patterns received by tapping on a helmet to which the system is attached. These improvements as well as others will be further described below.

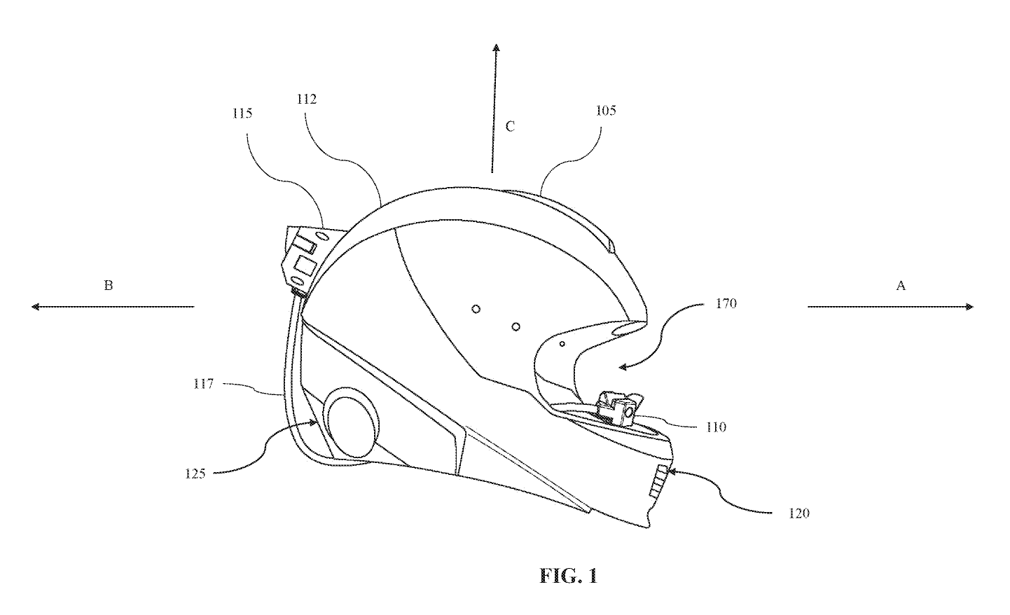

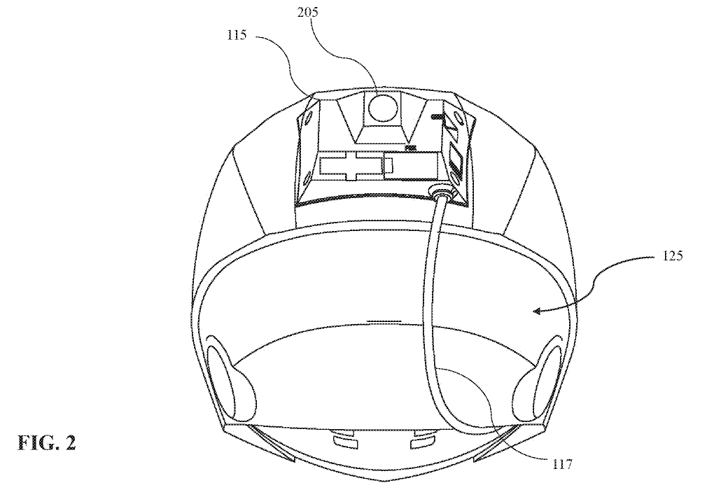

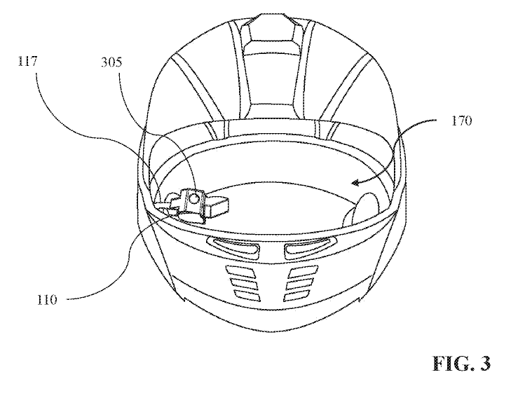

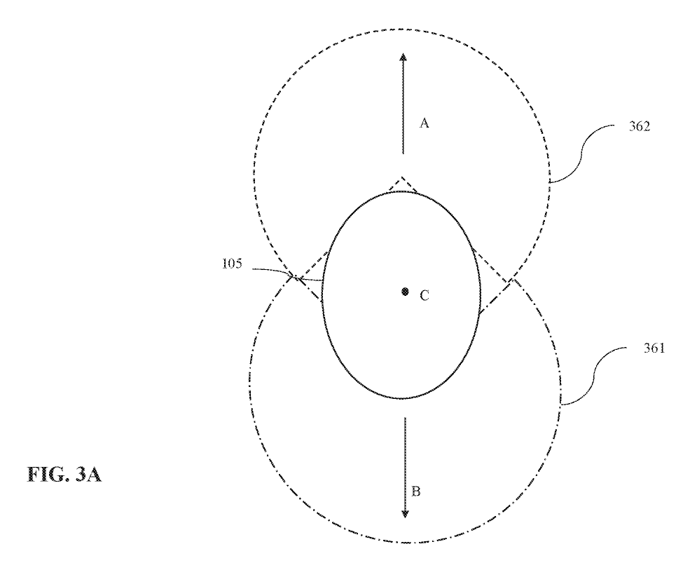

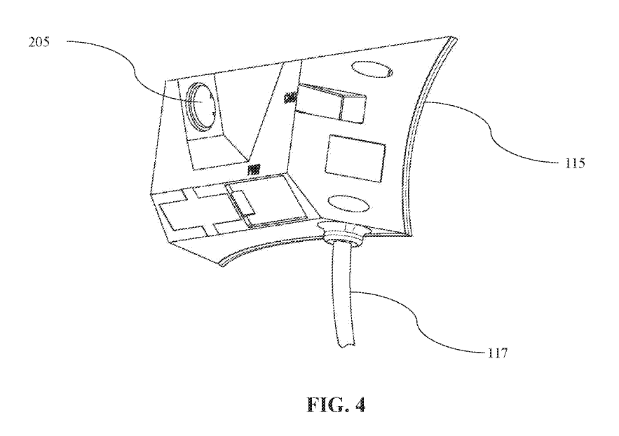

Referring now to the Figures, some of the figures will be discussed together where necessary, and some of the figures will be discussed alone where necessary. FIG. 1 is a side perspective view of a system or attachment 100 attached to a helmet 105, according to an example embodiment. FIG. 2 is a rear perspective view of the system or attachment for a helmet for monitoring, displaying, recording, and storing data, according to an example embodiment. FIG. 3 is a front perspective view of the system or attachment for a helmet for monitoring, displaying, recording, and storing data, according to an example embodiment. It is understood that the disclosed helmet is only example embodiments, and other helmets may also be used. For example, in the present embodiment of the disclosed helmet is a motorcycle helmet. However, other helmets used for other sports, such as skiing, snowboarding, hiking, skateboarding, motocross, cycling etc. may also be used and are within the spirit and scope of the present invention. In the present embodiment, the helmet 105 has a front end 120 opposing the rear end 125. The helmet also has a front opening 170.

In the present embodiment, the system includes a first housing 115. The housing may be formed from one of the following or a combination of one of the following materials: wood, alloys, metals, composites, ceramics, polymeric materials such as polycarbonates, such as Acrylonitrile butadiene styrene (ABS plastic), Lexan™, and Makrolon™. The first housing may be formed from a single piece or from several individual pieces joined or coupled together. The components of the first housing may be manufactured from a variety of different processes including an extrusion process, a mold, welding, shearing, punching welding, folding etc. However, other types of materials may also be used and are within the spirit and scope of the present invention.

In the present embodiment, the system includes a first housing 115 and a second housing 110. Each housing may be formed from one of the following or a combination of one of the following materials: wood, alloys, metals, composites, ceramics, polymeric materials such as polycarbonates, such as Acrylonitrile butadiene styrene (ABS plastic), Lexan™, and Makrolon™. Each housing may be formed from a single piece or from several individual pieces joined or coupled together. The components of the first housing may be manufactured from a variety of different processes including an extrusion process, a mold, welding, shearing, punching welding, folding etc. However, other types of materials may also be used and are within the spirit and scope of the present invention. As illustrated in FIGS. 1 and 2, the first housing is positioned and mounted on the helmet such that the records data from a second perspective or a rearward facing perspective (represented by line B as illustrated in FIG. 1). In the present embodiment, the first camera or first content capturing device is also adjustable so that the rearward facing perspective can be adjusted so that the data received or captured by the first camera or content capturing device may also be adjusted. The rearward-facing camera may also include a microphone or other data receiving elements in order to capture sound from the rearward-facing perspective.

In the present embodiment, the first housing 115 includes a first content capturing device or first camera. The content capturing device may be a camera capturing only visual content or data, a camera for capturing both audio and visual content or data, mirrorless cameras, action cameras, 360 cameras, digital cameras or any combination thereof. It is also understood that other content capturing devices or cameras also may be used and are within the spirit and scope of the present invention. The camera or content capturing device is encased within the housing such that the lens 205 is positioned such that it has access to the exterior or surroundings of the first housing so that able to capture visual data or content from the rearward facing perspective.

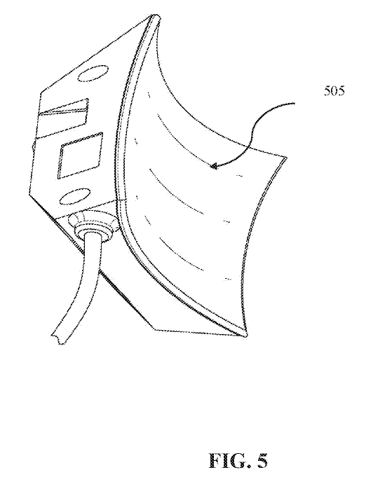

The first housing is for mounting onto an outward facing portion 112 of the helmet. Referring to FIG. 5, in the present embodiment, the first housing may include a curved surface 505 that is configured for matching the curved surface of the outward facing portion of the helmet. The present embodiments, the first housing will be mounted onto the helmet using fasteners or by using the adhesive material on the surface 505 that is configured for that hearing to the surface of the helmet. Each of the fasteners may include a suction cup, hooks, bolt, set crews, opening configured to attached to protruding element, socket screws u-bolts, twine, etc. However, other types of fasteners may also be used and are within the spirit and scope of the present invention. The adhesive may be a pressure sensitive adhesive comprising materials such as comprise lanolin, mineral oil, petrolatum, rosin, silicone, and zinc oxide. The backing may be made of material, such as wax paper or other materials used to protect adhesive materials. However, it is understood that other adhesive type materials will be also used and are within the spirit and scope of the present invention.

In the present embodiment, the first housing is positioned on the outward facing portion of the helmet such that the lens 205 of the first camera is positioned such that it captures visual data, audio visual data or other data from a rearward facing or first perspective (in the direction of line B). It is also understood that additional cameras that are within the spirit and scope of the present invention may also be used to capture audio visual data from other perspectives as well. The first content capturing device or first camera is configured for capturing first data. It is understood that the first data may include visual data, audio data, accelerometer type data as well as other data.

The first housing also encases or houses a sensor for capturing accelerometer data relative to the helmet, such as a bulk micromachined capacitive device, bulk micromachined piezoelectric resistive device, capacitive spring mass system base, DC response device, electromechanical servo device, (Servo Force Balance), high gravity device, laser accelerometer, GPS accelerometer, potentiometric type, triaxial, piezoelectric accelerometer or any combination thereof. It is understood that other types of accelerometers may also be used and are within the spirit and scope of the present invention. The sensor is configured for capturing accelerometer type data such as velocity, pitch, yaw, acceleration, deceleration etc. The sensor data or data received from the accelerometer may include position, location, velocity and acceleration values for the X, Y and/or z-axes.

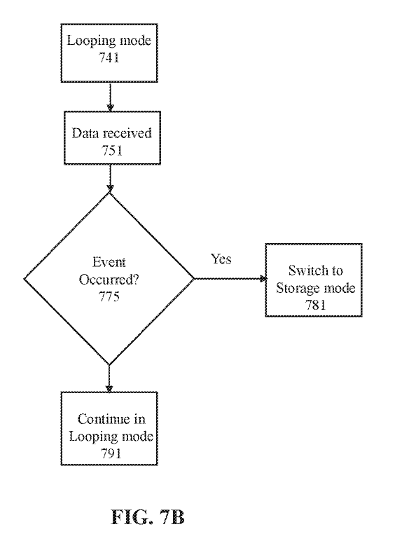

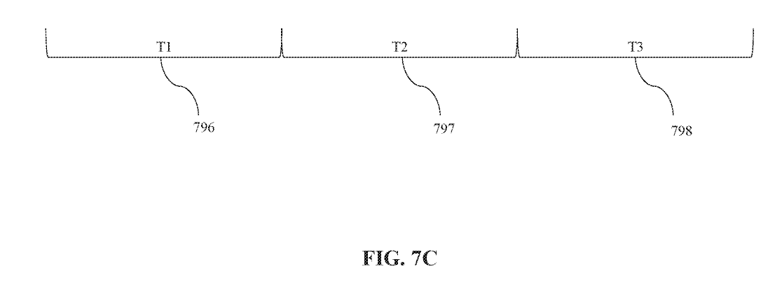

The first housing may also include a database (See FIG. 7 item 710) for storing the audio and/or visual data received from the first camera or first content capturing device, accelerometer type data received from the sensor, audio and/or visual data received from the second camera or second content capturing device (further explained below). The database may also be configured to store other data. The database may be a micro SIM card, nano SIM card, SD card, RAM, solid-state drive or flash memory (SSD), hard disk drive (HDD). However, it is understood that other types of databases may also be used and are within spirit and scope of the present invention.

The first housing may also include a processor or processing unit (See FIG. 715, item 715). The processing unit is in electrical or other communication with the first camera 705, the second camera 711, the sensor 760, the database 710 and a display 725, 605. The processing unit is configured for receiving data from the first content capturing device or first camera, data received from the second capturing device or second camera, and accelerometer data from the sensor, and storing first visual data or first data, second visual data or second data, and accelerometer data in the database, and for displaying a graphical representation on the display corresponding to at least the first visual data or first data, second visual data or second data, and accelerometer data.

The first housing is connected to the second housing 110. In one embodiment, the second housing is connected and is in electrical communication to second housing by an insulated conductor 117 configured to transmit signals and data. The second housing is configured for encasing a second camera or content capturing device 711 (see FIG. 7) configured for capturing a plurality of second visual data or second data from a second perspective relative to the helmet (represented by line A in FIG. 1). In the present embodiment, the second perspective is the content that is the forward-facing perspective of a user when the helmet is worn. In the present embodiment, the second camera is also adjustable so that the forward-facing perspective can be adjusted so that the data received from the second camera may also be adjusted. The forward-facing or second camera may also include a microphone or other data receiving elements in order to capture sound from the forward-facing perspective. The second content capturing device or second camera is configured for capturing data. It is understood that such data may include visual data, audio data, accelerometer type data as well as other data. The second content capturing device may be a camera capturing only visual content, a camera for capturing both audio and visual content, mirrorless cameras, action cameras, 360 cameras, digital cameras or any combination thereof. It is also understood that other content capturing devices also may be used and are within the spirit and scope of the present invention. The camera or content capturing device is encased within the housing such that the lenses is able to capture content.

Data received by the second camera or second content capturing device is transmitted through connector 117 that provides the data to the processor (as illustrated in FIG. 7), which is located in the second housing 115. The display element 605 is such that a user can view their rearview perspective of data received from the first camera 705.

The second housing also encases a display 725, 605 configured to be positioned such that a user can view the display when the helmet is worn by the user and the lens 305 of the second camera is positioned such that it has access to the exterior or surroundings of the second housing so that able to capture visual data or content from the forward facing perspective. In the present embodiment, the display may comprise an LED display, a Cathode ray tube display (CRT), Electroluminescent display (ELD), Plasma display panel (PDP), an Liquid crystal display (LCD), Organic light-emitting diode display (OLED), Digital microshutter display (DMS). However it is understood that other displays may also be used and are within the spirit and scope of the present invention.

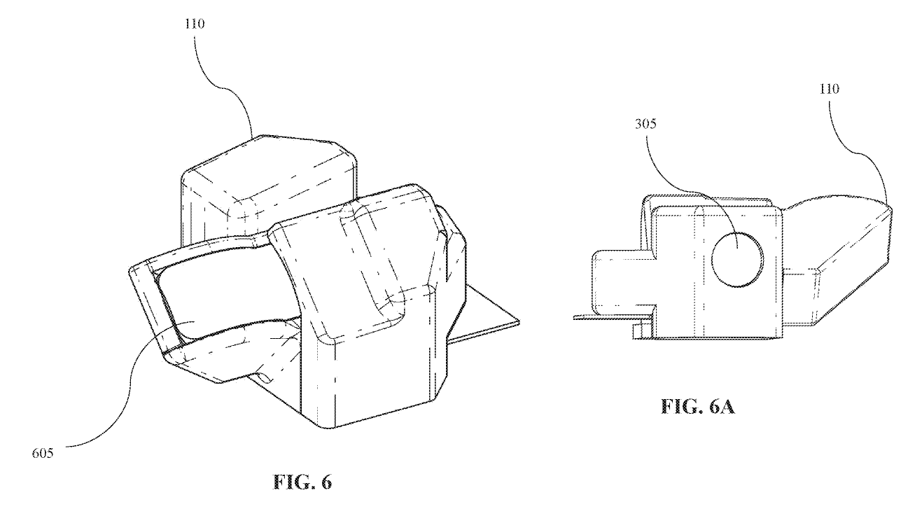

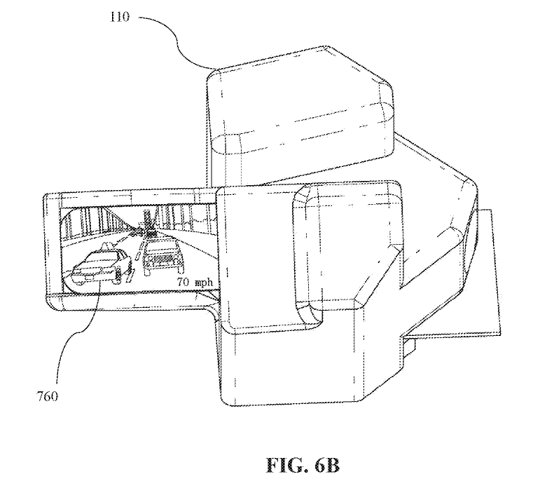

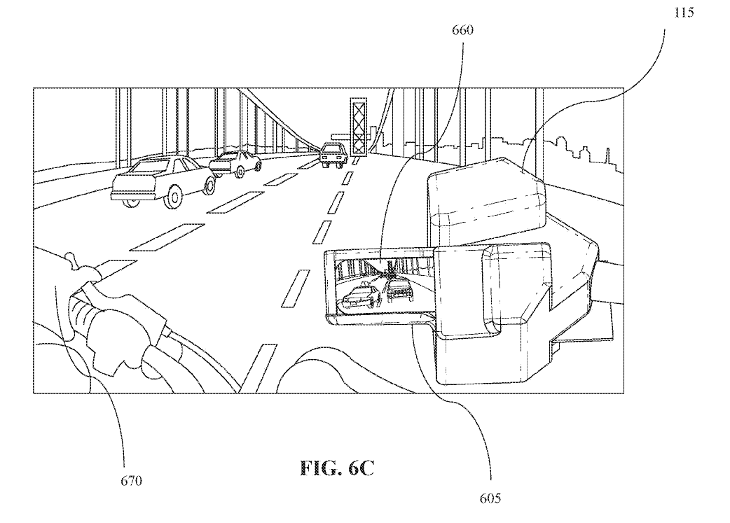

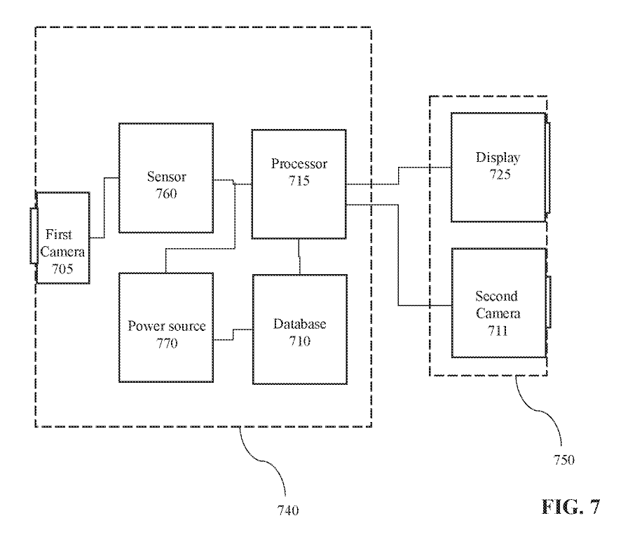

Referring to FIGS. 6B and 6C, the display is for displaying a graphical representation 660 on the display corresponding to at least the first visual data or first data. FIG. 6B is a second perspective view of the second housing illustrating a graphical representation of visual data displayed on the display, according to an example embodiment, and FIG. 6C is a third perspective view of the second housing illustrating a graphical representation of visual data displayed on the display while worn by a user, according to an example embodiment. In other words, in one embodiment, the display displays on the display or screen the rear-view or view or perspective from behind the helmet so that a wearer when wearing the helmet can easily view the what is behind him or her. Additionally, the display may display or provide a graphical representation of other data received by the system such as velocity, acceleration, GPS location, map location etc. However, it is also understood that other graphical representations of data may also be displayed on the display 725, 605 and are also within the spirit and scope of the present invention. In the present invention, the graphical representation 660 is a graphical representation of the data received from the first camera or content capturing device. In the present embodiment as illustrated in FIGS. 6B and 6C, the graphical representation is of the rearview rearward facing perspective or rear view. In FIG. 6C, illustrates a user 670 operating a motorcycle and wearing a helmet having the attachment attached thereto. The second housing 115 is positioned such that the display 605 displays a graphical representation 660 of the data captured from the first content capturing device or camera positioned such that it captures data from the rear perspective relative to the helmet.

After information is received by the sensor, it is transmitted to the processor to determine if a crash event has occurred, which may be performed by the processing unit within the second housing. The processor configured to determine if an event has occurred, wherein the event occurs if a threshold change or predetermined change in accelerometer data is received. For example, the threshold change may be a rapid velocity, acceleration, deceleration, changes axes, etc. Additionally, the processor may also be configured to determine if a rapid change or the threshold change in visual data or optical is received in order to determine if an event or crash has occurred. For example, the processor may be configured to analyze the more visual data from the first content capturing device or second content capturing device to determine if an event has occurred based upon an extreme rapid change in visual data not associated with normal driving patterns or movement patterns. In some embodiments, in accelerometer or sensor specifically for receiving accelerometer type data may not be required if the process servers are configured for determining if an event has occurred based upon audio or visual data received.

FIG. 7B is a process flow diagram of illustrating one of the processes of the system or attachment for a helmet for monitoring, displaying, recording, and storing data, according to an example embodiment. The processor 715 is also configured to have both a looping mode and storing mode. The default setting is for the system to run a looping mode as illustrated in step 741. In a looped or looping mode, data (first visual or first data, second visual or second data, and accelerometer received from the accelerometer) during a first-time period is stored in the attached database until data (first visual or first data, second visual or second data, and accelerometer received from the accelerometer) received from the system during a second-time period is received and stored in the attached database. The processor is also configured to determine if an event or traffic event occurs. A traffic event or event may signify a crash or incident that may causes bodily injury or property damage or that will be of particular interest. In step 751, the process is configured to continually receive data from the first content capturing device or camera, second content to capturing device or camera, and accelerometer. Using the data received during step 751, the processor is configured for determining if a crash or event has occurred or been detected 775. For example, in one embodiment the processor may determine if an event occurs if the processor determines that a threshold change in data received from the first content capturing device, second content capturing device or senor is received. In one embodiment, an event occurs if the processor determines that a threshold change in accelerometer data is received from the sensor. For example, the processor may include algorithms that determine if a threshold of a greater than 40 mile per hour (MPH) decrease in velocity is received based upon accelerometer type data. If the processor determines that a greater than 40 MPH decrease in velocity is received, then the processer determines that an event has occurred. However, it is understood that other means of determining threshold changes in velocity or acceleration may also be used to determine if a crash or an event has occurred that are within the spirit and scope of the present invention. For example, the processer may analyze the visual data from the first content capturing device or second content capturing device to determine will velocity at an instant point in time and determine if a threshold change has based upon those values.

FIG. 7C is a diagram of the time periods, for illustrative purposes, during which data is captured by a first data capturing device and second data capturing device of the system or attachment for a helmet for monitoring, displaying, recording, and storing data, according to an example embodiment. Referring to FIGS. 7 through 7C, in the looping mode 741, if any traffic event does not occur, then the system is configured to record over old data in the database 710 and continues in looping or looped mode 791. In the looping mode, first visual data or first data, second visual data or second data, and accelerometer data received from a first time period is stored in the database until first visual data or visual data, second visual data or second data and accelerometer data received from a second time period is received and stored in the database. For example, FIG. 7C illustrates three sequential predetermined time periods, T1 (796), T2 (797) and T3 (798), respectively. In the looping mode data received during the T1 time period is stored in the database. If the processer determines that no event has occurred, then data received during the second time period T2 is recorded over the data received during the time period T1 so that memory in the database is conversed. If no event occurs during the second time period T2, then the system records over the data received during time period T2 and stores or records the data received during the third time period T3 conserving memory in the database. The looping mode or looped mode continues to record over the previous time period unless the processor determines that event occurs. It is understood the time periods may vary depending on function, but may be 1 minute, 5 minutes, 10 minutes predetermined time periods. However, it is understood that other predetermined time periods are within the spirit and scope of the present invention.

If the processor determines that an event has occurred than the process switches to the storing or storage mode 781. In the storing mode data (first visual data or first data, second visual data or second data and accelerometer data) received from a time period before an event occurs and after an event occurs in the database. The storing mode allows data to be stored that occurs both before and after an event occurs so that investigators can use the data to determine how the event happened. For example, referring to FIG. 7C, if an event occurred between T2 and T3, the system and process will switch to the storing mode and will record data (first visual data or first data, second visual data or second data and accelerometer data) in the database for at least a predetermined amount of time or portion of T2 and for at least a predetermined amount of time or portion of T3. The predetermined amount of time may be varied depending on function. For example, the predictor time may be five minutes, 10 minutes, 15 minutes, half an hour, one hour. etc or any combination thereof. Therefore, when an even occurs the system records data both before and after the incident so that it may used for investigative purposes.

In the storing mode, after a traffic event occurs, a timer or countdown sequence is initiated for a predetermined amount of time such that when the timer expires or ends, the recording of the data ceases. The process is also configured such that data can be retrieved and analyzed from the attached database.

Additionally, the accelerometer or sensor 760 is configured to control the system using a plurality of predetermined patterns of motion detected by the sensor. For example, if the sensor detects a certain pattern of tapping on a helmet, that can be used to turn on or off the system. For example, a user may tap the side of the helmets twice within a short period of time, and a response, the display darkness or lightens can be adjusted. By way of another example, the user may also nod their head in a predetermined pattern to control the system. Additionally, another pattern of tapping on the helmet may turn on or off the system. This controlling by tapping provides motorcycle riders the ability to keep their riding gloves on a cold weather or as a safety precaution. The bulkiness of gloves can make it cumbersome to interact with buttons or other interactive devices and as a result this “hands-free” mode providing a feature that is not disclosed by the prior art.

FIG. 7 is a block diagram of the main electrical elements of the system for monitoring, displaying, recording, and storing data. The first housing is represented by dashed line 740. The second housing is represented by the dashed line 750. As illustrated in FIG. 7, the display 725 and second camera 711, are both in communication with the processor 715 within the first housing.

The processor is also in communication with to the attached database 710. The first camera or first content capturing device 705 and sensor 760 is also in communication with the processor. In addition, the system is also in communication with the power source 770. In operation, when the user wears a helmet, he or she may control the device by using a predetermined pattern of motion, such as nodding his or her head, or tapping on the helmet, to control the system. Next, data received from the first camera or first content capturing device 705 is communicated to the processor 715. Similarly, data received from the second camera or second content capturing device 711 and accelerometer data from the sensor 760 is also transmitted to the processor. Referring to FIG. 3A, 3A is a diagram of a top view perspective of a helmet, illustrating the front prospective, rear perspective and areas surrounding the helmet that the first and second cameras may record, according to an example embodiment. The first camera and second camera capture data for at least 320 degrees relative to a central axis of the helmet. An exemplary coverage radius that the camera may capture is represented by first dashed curved line 361 and an exemplary coverage radius that the second camera may capture is represented by first dashed curved line 361. The combination of the first and second camera allow for the system to capture at least a 320-degree radius surrounding the main axis or central axis (represented by line C in FIG. 1 and dot C in FIG. 3A). This provides an advantage for investigative purposes in that it provides a greater coverage area that a single camera.

The processor will continue to provide a graphical representation of rear view perspective to the display 725, 605, so that the rider can view what is behind him or her. Additionally, the processor will monitor the data from the sensor, the first content capturing device data or first camera and second content capturing device or second camera to determine if an event or accident has occurred. If the predetermined threshold change in accelerometer data (velocity change, acceleration change) is received, for example if there is a rapid deceleration, then the system will move from looping mode to storing mode. As mentioned above, in the storing mode, the processor stores in the attached database 710 data received from both the first and second cameras and the accelerometer data for a predetermined amount of time before and after the crash event. Also worth noting is that other data including sound, time, etc. may also be recorded in the attached database.

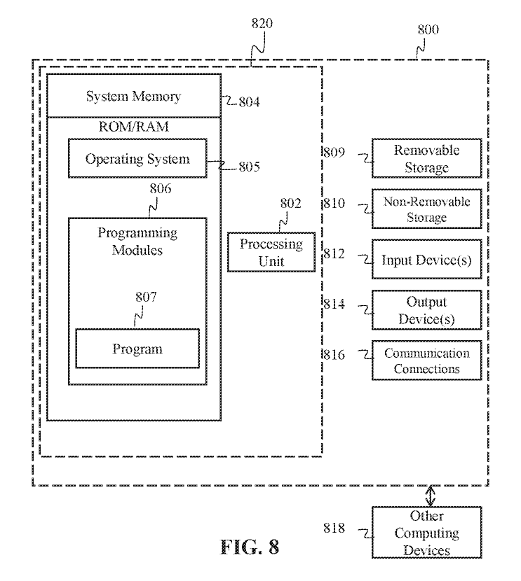

FIG. 8 is a block diagram of an example computing device or processor 800 and other computing devices. Consistent with the embodiments described herein, the aforementioned actions performed by processor 715 may be implemented in a computing device, such as the computing device 800 of FIG. 8. Any suitable combination of hardware, software, or firmware may be used to implement the computing device 800. The aforementioned system, device, and processors are examples and other systems, devices, and processors may comprise the aforementioned computing device.

With reference to FIG. 8, a system consistent with an embodiment of the invention may include a plurality of computing devices, such as computing device 800. In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination or memory. System memory 804 may include operating system 805, one or more programming modules 806 (such as program module 807). Operating system 805, for example, may be suitable for controlling computing device operation. In one embodiment, programming modules 806 may include, for example, a program module 807. Furthermore, embodiments of the invention may be practiced in conjunction with a graphics library, other operating systems, or any other application program and is not limited to any particular application or system. This basic configuration is illustrated in FIG. 8 by those components within a dashed line 820.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable and non-removable media implemented in any method or technology for storage of information, such as computer readable instructions, data structures, program modules, or other data. System memory 804, removable storage 809, and non-removable storage 810 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a camera, a touch input device, etc. Output device(s) 814 such as a display, speakers, a printer, etc. may also be included. The aforementioned devices are only examples, and other devices may be added or substituted.

Computing device 800 may also contain a communication connection 816 that may allow device 800 to communicate with other computing devices 818, such as over a network in a distributed computing environment, for example, an intranet or the Internet or wirelessly with devices 830 and 835. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), wireless communication includes wireless Bluetooth® technology, WIFI, infrared, and other wireless media. The term computer readable media as used herein may include both computer storage media and communication media.

As stated above, a number of program modules and data files may be stored in system memory 804, including operating system 805. While executing on processing unit 802, programming modules 806 may perform processes including performing sound processing functions such as signal processing, digital processing, etc. Computing device 802 may also include a graphics processing unit 803, which supplements the processing capabilities of processor 802 and which may execute programming modules 806, including all or a portion of those processes identified or alluded to above. The aforementioned processes are examples, and processing units 802, 803 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, thumb drives, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. An attachment for a helmet comprising:
a first housing for mounting onto an outward facing portion of the helmet, the first housing for encasing:
a first camera configured for capturing a plurality of first visual data from a first perspective relative to the helmet;
a sensor for capturing accelerometer data relative to the helmet;
a database for storing the first visual data, second visual data and accelerometer data;
a processing unit in communication with the first camera, the second camera, the sensor, the database and a display, wherein the processing unit is configured for receiving first visual data, second visual data, and accelerometer data, storing first visual data, second visual data, and accelerometer data in the database, and for displaying a graphical representation on the display corresponding to at least the first visual data; and,
a second housing connected to the first housing the second housing for encasing:
a second camera configured for capturing a plurality of second visual data from a second perspective relative to the helmet; and,
the display configured to be positioned such that a user can view the display when the helmet is worn by the user.

2. The attachment of claim 1, wherein the first camera is configured to be positioned on the helmet such that the first perspective is a rearward-facing perspective.

3. The attachment of claim 1, wherein the second camera is configured to be positioned on the second such that the second perspective is a forward facing perspective.

4. The attachment of claim 1, wherein the first camera and camera capture data for at least 320 degrees relative to a central axis of the helmet.

5. The attachment of claim 1, wherein the processor is configured to determine if an event has occurred, wherein the event occurs if the processor determines that a threshold change in accelerometer data is received from the sensor.

6. The attachment of claim 5, wherein the processor switches from a looping mode to a storing mode after the event has occurred;
wherein in the looping mode first visual data, second visual data and accelerometer data received from a first time period is stored in the database until first visual data, second visual data and accelerometer data received from a second time period is received and stored in the database; and,
wherein in the storing mode first visual data, second visual data and accelerometer data received from a third time period and a fourth time period is stored in the database after the event occurs, wherein the third time period is a first predetermined amount of time before the event occurs, and wherein the fourth time period is a second predetermined amount of time after the event occurs.

7. The attachment of claim 5, wherein the threshold change is a first predetermined change in velocity.

8. The attachment of claim 6, wherein the threshold change is a second predetermined change in acceleration.

9. A system for monitoring, recording, and displaying environmental data comprising:
a first data capturing device for mounting on the helmet such that it records a plurality of first data from a first perspective relative to the helmet;
a second data capturing device for mounting on the helmet such that it records a plurality of second data from a second perspective relative to the helmet;
a display connected to the housing and configured to be positioned such that a user can view the display when the helmet is worn by the user, wherein the display is configured to present a graphical representation of at least the first data;
a database for storing at least the first data and second data; and,
a processing unit in communication with the first data capturing device and second data capturing device, database and display, wherein the processing unit is configured for receiving first data and second data, storing first data and second data in the database, determining if an event occurs, and for displaying the graphical representation on the display corresponding to at least the first data.

10. The system of claim 9, wherein the processor is configured to determine if an event has occurred, wherein the event occurs if the processor determines that a threshold change in first data or second data is received by the processor.

11. The system of claim 10, wherein the threshold change indicates a predetermined change in velocity.

12. The system of claim 9, wherein the processor switches from a looping mode to a storing mode after the event has occurred;
wherein in the looping mode first data and second data received from a first time period is stored in the database until first data and second data received from a second time period is received and stored in the database; and
wherein in the storing mode first data and second data received from a third time period and a fourth time period is stored in the database after the event occurs, wherein the third time period is a first predetermined amount of time before the event occurs, and wherein the fourth time period is a second predetermined amount of time after the event occurs.

13. The attachment of claim 9, wherein the first data capturing device is configured to be positioned on the helmet such that the first perspective is a rearward facing perspective, wherein the first data capturing device is configured to capture audio-visual content.

14. The system of claim 9, wherein the second data capturing device is configured to be positioned on the helmet such that the second perspective is a forward-facing perspective, wherein the first data capturing device is configured to capture audio-visual content.

15. A system for monitoring, recording, and displaying data comprising:
a first housing for mounting onto an outward facing portion of a helmet, the first housing for encasing:
a first camera for mounting on the helmet such that it records a plurality of first visual data from a first perspective relative to the helmet;
a second camera for mounting on the helmet such that it records a plurality of second visual data from a second perspective relative to the helmet;
a database for storing at least the first visual data and second visual data; and,
a processing unit in communication with the first camera, second camera, database and a display, wherein the processing unit is configured for receiving first visual data and second visual data, storing first visual data and second visual data in the database, and for displaying a graphical representation on the display corresponding to at least the first visual data;
wherein the processor is further configured to determine if an event has occurred by determining if a threshold change in first visual data or second visual data is received, and wherein the processor switches from a looping mode to a storing mode after the event has occurred;
wherein in the looping mode first visual data and second visual data from a first time period is stored in the database until first visual data and second visual data received from a second time period is received and stored in the database; and,
wherein in the storing mode first visual data and second visual data received from a third time period and a fourth time period is stored in the database after the event occurs, wherein the third time period is a first predetermined amount of time before the event occurs, and wherein the fourth time period is a second predetermined amount of time after the event occurs;
a second housing in communication with the first housing for encasing:
a second camera configured for capturing a plurality of second visual data from a second perspective relative to the helmet; and,
the display configured to be positioned such that a user can view the display when the helmet is worn by the user.

16. The system of claim 15, wherein the first camera is configured to be positioned on the helmet such that the first perspective is a rearward-facing perspective, wherein the first camera is configured to capture audio-visual content.

17. The attachment of claim 15, wherein the second camera is configured to be positioned proximate the helmet such that the second perspective is a forward facing perspective, wherein the second camera is configured to capture audio-visual content.

18. The system of claim 15, wherein the threshold change is a first predetermined change in velocity.

19. The system of claim 15, wherein the system further includes a sensor for a sensor for capturing accelerometer data relative to the helmet.
